(19) United States
(12) Patent Application Publication
(10) Pub. No.: US 2009/0125950 A1
(43) Pub. Date: May 14, 2009

(54) METHOD AND SYSTEM FOR AUTHENTICATING A USER DEVICE

(76) Inventors: Kapil Chaudhry, Cerritos, CA (US); Alistair E. Jeffs, Los Angeles, CA (US); Jennifer S. Staggs, Los Angeles, CA (US); Matthew J. Thompson, Torrance, CA (US); Tom Y. Liang, Huntington Beach, CA (US); James R. Butterworth, Rancho Palos Verdes, CA (US); Gilbert Zaldivar, Rancho Santa Margarita, CA (US); Thai Lam, Torrance, CA (US); Amy K. Tsao, Redondo Beach, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(21) Appl. No.: 11/938,570

(22) Filed: Nov. 12, 2007

(51) Int. Cl. H04N 7/20; H04H 40/00; H04N 7/173

(52) U.S. Cl. 725/64; 455/3.06; 455/414.1; 725/105; 725/5

(57) ABSTRACT

A system and method includes a user device having a subscriber activation client application stored therein. The user device prompts entry of an ordering identifier and receives the ordering identifier through a user interface. A subscriber activation system is in communication with the user device through a secure network. The subscriber activation system receives the ordering identifier from the user device. The subscriber activation system verifies the ordering information and generates an activation signal from the order identifier. The subscriber activation system communicates the activation signal to the user device to activate the user device.

### TECHNICAL FIELD

The present disclosure relates generally to communication systems using authorized user devices, and, more particularly, to a method and system for activating a user device for communication within the network.

### BACKGROUND

The statements in this section merely provide background information related to the present disclosure and may not constitute prior art.

Communication networks often require secure communication to distinguish between authorized and unauthorized users. Typically, a user device is introduced into the system by activating the user device.

One type of communication system using device activation is a satellite communication system such as a satellite television system. In a satellite television system, the set top box is activated so that it may communicate and receive signals. In the current DIRECTV® satellite television system, an installing engineer or customer calls a customer service representative to perform activation. The customer service representative enters various information received by asking the installing engineering various questions.

Each installation takes a finite amount of time and, therefore, a customer service representative must spend a substantial amount of time for each new installation. The cost of labor for a customer service representative is expensive. Due to the competitive nature of television subscription broadcasting systems, reducing costs is important.

### SUMMARY

The present disclosure allows the user device to be activated with less manpower. That is, a customer service representative is not required to perform the activation.

In one aspect of the disclosure, a method of activating a user device includes connecting a user device to a communication network, communicating from the user device to a subscriber activation system through the communication network, entering an ordering identifier into the user device, communicating the ordering identifier to the subscriber activation system, verifying the order identifier, generating an activation signal from the order identifier, and communicating the activation signal to the user device to activate the user device.

In a further aspect of the disclosure, a method includes a user device having a subscriber activation client application stored therein. The user device prompts entry of an ordering identifier and receives the ordering identifier through a user interface. A subscriber activation system is in communication with the user device through a secure network. The subscriber activation system receives the ordering identifier from the user device. The subscriber activation system verifies the ordering information and generates an activation signal from the order identifier. The subscriber activation system communicates the activation signal to the user device to activate the user device.

In yet another aspect of the disclosure, a method of activating a satellite television set top box includes connecting the satellite television set top box to a subscriber activation system through a communication network, storing subscriber activation client application on the satellite television set top box, activating the subscriber activation client application by accessing a channel in the satellite television set top box, entering an ordering identifier into the satellite television set top box in response to prompts from the subscriber activation client, communicating the ordering identifier to the subscriber activation system through the communication network, verifying the order identifier, generating an activation signal from the order identifier and communicating the activation signal to the satellite television set top box through the satellite to activate the user device.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic view of a subscriber activation system according to the present disclosure.

FIG. 2 is a flowchart of a method for operating a subscriber activation system.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDs) as described below can be reallocated as desired without departing from the intended scope of the present patent.

Further, while the following disclosure is made with respect to the delivery of content (e.g., television (TV), movies, games, music videos, etc.), it should be understood that the systems and methods disclosed herein could also be used for delivery of any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein. As used herein, the term title or program will be used to refer to, for example, a media content type such as a movie itself and not the name of the movie.

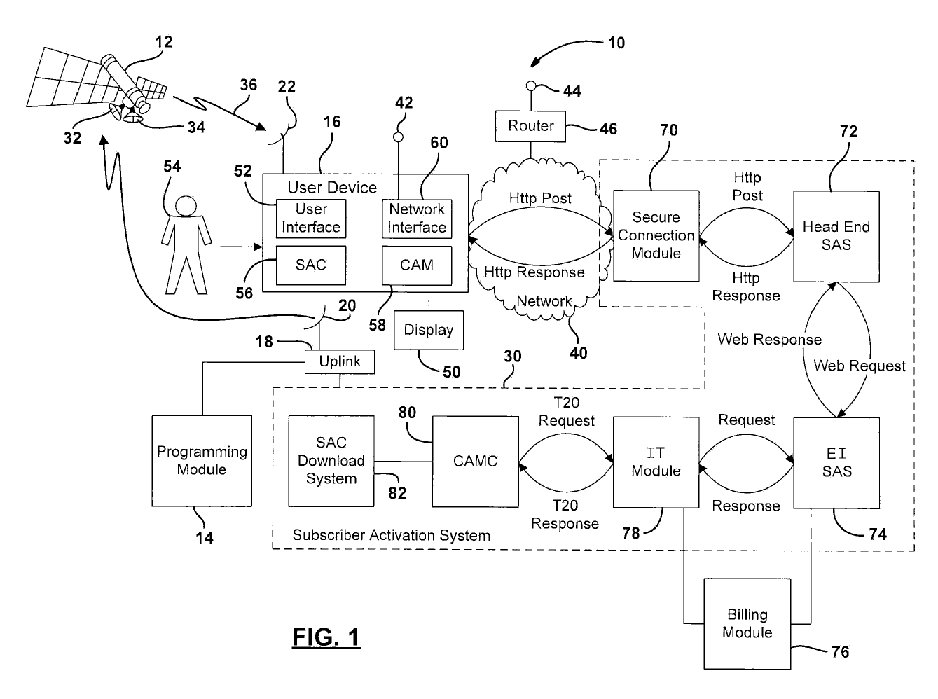

Referring now to FIG. 1, a satellite television broadcasting system 10 is illustrated. The satellite television broadcasting system 10 is illustrated by way of example and, as mentioned, the present disclosure is not limited thereto. The satellite television broadcasting system 10 includes a satellite 12 that receives programming from a programming module 14 and communicates the programming to a plurality of user devices 16, one of which is illustrated. The programming module 14 provides programming content to an uplink system 18 which is uplinked to the satellite 12 through an uplink antenna 20. A downlink antenna 22 incorporated into an outdoor unit receives the programming therethrough. A subscriber activation system 30 may also be in communication with the uplink system 18. The subscriber activation system 30 may be used to activate the user device 16 so that it is authorized to receive the programming from the programming module 14. The satellite 12 includes a receiving antenna 32 that receives wireless communication signals from the uplink antenna 20. The satellite 12 also includes a transmitting antenna 34 used to communicate downlink signals 36 to the antenna 22 of the user device. The wireless communication signals may be various types of entertainment content, traffic, weather, hazardous material warnings, and advertising marketing. As mentioned above, this system may also be suitable for wired systems such as cable television systems.

The user device 16 may include a satellite television set top box. Of course, other types of user devices may be used such as a cable television set top box. Other types of user devices may include a mobile device such as a laptop computer, a cellular phone, a personal digital assistant, a portable media player, or an automotive-based television-receiving device.

The user device 16 is in communication with the subscriber activation system 30 through a network 40. The network 40 may be a secure network or uses a secure protocol. The network 40 may include a broadband network through which the user device communicates. The broadband network 40 may be a wired network such as a public-switched telephone network (PSTN) or a broadband network. The broadband network may communicate wired, wirelessly or a combination of both. For example, the user device 16 may include a wireless antenna 42 for communicating with an antenna 44 of a router 46 which, in turn, is in communication with the network 40. Activation signals that include activation information provided from the user device and confirmation information such as confirmation of a signal being received at the subscriber activation system 30. The communication between the user device 16 and the subscriber activation system 30 may be formed using hypertext transfer protocol. For example, a hypertext transfer protocol post may be used to communicate signals and information from the user device 16 to the subscriber activation system 30. A hypertext transfer protocol response may be used to communicate between the subscriber activation system 30 and the user device 16.

The user device 16 may be associated with a display 50 for displaying the programming as well as displaying various types of activation commands, or the like. The display 50 may be a television or an integrated display. The user device 16 may include an interface 52 such as a keyboard, remote control, or the like for selecting and entering various types of information by a client or installing engineer 54.

The user device 16 may also include a subscriber activation client (SAC) application 56. The subscriber activation client application 56 may be an interactive application stored in the memory of the user device 16. The subscriber activation client application 56 may be software stored within the memory of the user device 16 at manufacturing or upon download.

The user device 16 may also include a conditional access module 58 that allows the user device to access the programming provided from the programming module 14. The conditional access module 58 may include various activation codes without which the user device is not activated. Prior to activation, the activation codes are not stored therein. Thus, the user device 16 must have the conditional access module 58 activated in order to allow the user device 16 to properly communicate services.

The user device 16 may also include a network interface 60 for communicating wirelessly or wired as mentioned above. For example, the network interface may include a wireless broadband interface, a wired broadband interface, or a modem-type communication system through a public-switched telephone network.

The subscriber activation system 30 may include a secure connection module 70 that is used for securely communicating with the user device 16 through the network 40. The secure connection module 70 may be referred to as an interactive video guard (IVG) module. The secure connection module 70 may receive information signals in various ways, including wired and wirelessly. Information from the user device 16 may include an order identification and an account identifier. Other information received from the user device may include a receiver identification. The receiver identification may be automatically transmitted, whereas the order ID and account number may be entered through the user interface 52 and communicated through the network 40. The receiver ID may be stored in a memory of the user device. Other information may include the Smart card or cam card identifier, a subscriber identifier, a zip code, and set top box identifiers such as a manufacturer identifier, a model number or IRD serial number.

The secure connection module 70 may be in communication with a head end subscriber activation server 72. The subscriber activation server may be used to verify the receiver ID and a conditional access module identifier received through the network 40 from the user device 16. The head end subscriber activation server (SAS) 72 may communicate with the secure connection module 70 using hypertext transfer protocol. The head end subscriber activation server 72 may also be used to set up an account should an account not be provided.

The head end subscriber activation server 72 may be in communication with an enterprise integration (EI) subscriber activation server (SAS) 74. Communication between the head end subscriber activation server 72 and the enterprise integration subscriber activation server 74 may be through a web-based system providing web requests and web responses.

The enterprise integration subscriber activation server 74 may be in communication with a billing module 76. The billing module 76 may be within the subscriber activation system or outside the subscriber activation system 30. The billing module 76 and the enterprise integration subscriber activation server 74 may be in communication with an information technology (IT) module 78. The enterprise integration module verifies the information received from the user device such as the receiver ID and the conditional access module identifier. Either one or both of the enterprise integration subscriber activation server 74 or the IT module 78 may perform the verification through the billing module 76.

The IT module 78, upon verification of the account information through the billing module 76, requests an activation signal to be generated. The activation signal may correspond to a conditional access packet transmitted through the satellite 12.

The IT module 78 requests the authorization signal or activation signal to be generated through the conditional access management center 80. The conditional access management center 80 generates the activation signal, such as the conditional access packet, which is provided to the uplink system 18 and communicated to the satellite 12 through the uplink antenna 20. The satellite 12 then relays the activation signal to the user device 16. Once stored in the user device 16, the user device 16 is then part of the communication network 20 and may receive programming from the programming module 14.

The subscriber activation system 30 may also include a subscriber activation client download system 82. The subscriber activation client application may be communicated to the uplink system 18 and through the satellite 12. Once the user device 16 is in communication with the satellite 22, the user device 16 may receive the subscriber activation client application from the satellite 12. The subscriber activation client application may be continually and repeatedly broadcast through the satellite 12 on a specific channel then stored within the user device 16. To initiate the subscriber activation client, the client or installing engineer 54 merely tunes the user device 16 to a particular channel which is not a broadcast channel but a virtual channel provided at the user device 16. The user device 16 then queries the client or installing engineer 54 to enter various information through the user interface 52. The information is then communicated to the subscriber activation system 30 through the network 40. Further details of the method are provided below.

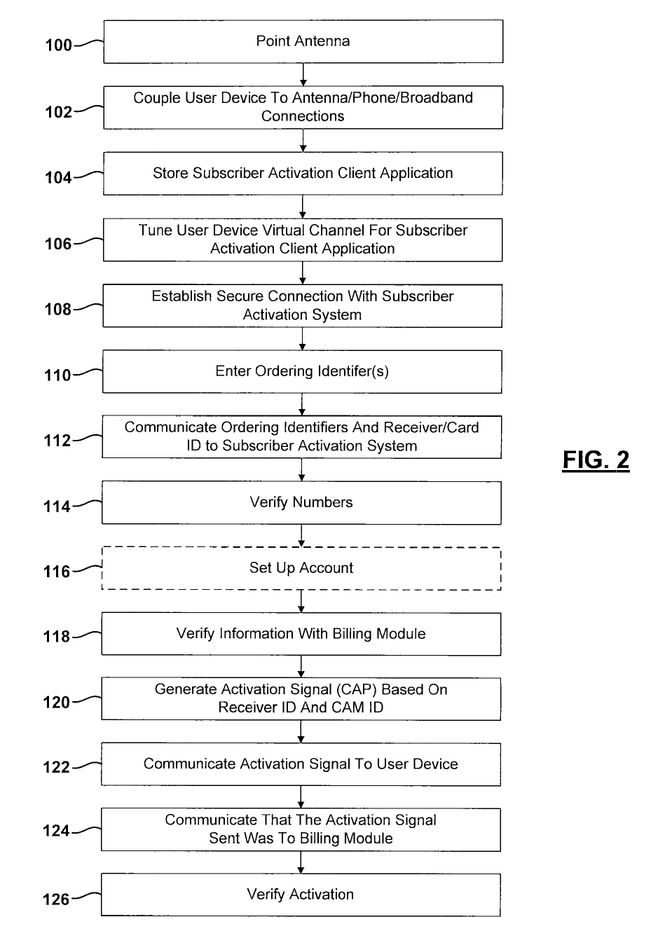

Referring now to FIG. 2, a method of activating a user device is illustrated. In step 100, the antenna 22 of FIG. 1 is pointed to the satellite. If a non-satellite system is used, the terrestrial antenna 42 may be used or a wired connection may be provided. In step 102, the user device is coupled to the antenna and to a communication network. As mentioned above, the communication network may be a phone or a broadband connection. By coupling the user device to the antenna, the subscriber activation client application may be communicated to the device. It should also be noted that the subscriber activation client may be pre-loaded within a memory of the user device 16.

In step 106, the user device is tuned to a particular channel from the set top box which acts as a virtual channel that activates the subscriber activation client application. The virtual channel may not be a broadcast channel in the traditional sense, but a channel that resides in the user device for the subscriber activation client. The virtual channel may be tuned by selecting a particular channel number through the user interface 52 illustrated in FIG. 1.

In step 108, a secure connection is established with the subscriber activation system. As mentioned above, the secure connection may be made through a communication network such as a wired network that includes a public-switched telephone network or a wireless network. The network may be a broadband network.

In step 110, the various ordering identifiers are prompted to be entered using the subscriber activation client. The ordering identifiers are entered through the user interface 52 in response to prompts displayed on the display 50 of FIG. 1. Various types of ordering identifiers may be provided and include the order ID, the account ID, the conditional access module identifier and other identifiers such as the ones described above. The receiver ID may also be entered. However, the receiver ID may also be stored within a memory of the user device so that it does not need to be entered.

In step 112, the ordering identifiers and the receiver identification and conditional access module identifier or card identifier is communicated through the secure network connection to the subscriber activation system 30 of FIG. 1. In step 114, the subscriber activation system may verify numbers by determining a check sum, or the like. The check sum may be performed on the receiver ID or various other identifiers. In step 116, the optional step of setting up an account is provided. An account may be established upon ordering the set top box. However, an account may also be set up at the time of activation. For example, set top boxes may be provided directly from a manufacturer unless at least some preliminary information may be provided. However, a retail store may also provide the user devices without establishing an account. Thus, the user interface 52 in connection with the user or installer 54 entering information may set up an account in this manner. In step 118, various information may be verified with the billing module 76 of FIG. 1. For example, the conditional access module identifier may be verified. Likewise, various other information entered may be used for verifying the proper account and equipment status. In step 120, the conditional access packet or activation signal may be generated at the conditional access management center 80 of FIG. 1. The activation signal may be based upon the receiver ID and the conditional access module or access card identifier, or both. Of course, other information may be used when forming the activation signal or CAP. In step 122, the activation signal is communicated through the uplink signal 18 to the user device 16 through the satellite 12 of FIG. 1. In a non-satellite system, the activation signal may be communicated from the subscriber activation system to the user device using a suitable communication network.

Once the activation signal is sent, the fact that the activation signal was sent may be communicated to the billing module in step 124. This enables the account to be activated and thus the user device 16 is now part of the communication system. This allows programming to be provided from the programming module 14 and used within the user device 16.

In step 126, activation may be verified in other manners, including providing a communication signal through the network 40 from the user device 16 so that the subscriber activation system receives a positive identifier. The activation may also be verified through the client or installing engineer being able to access programming through the module. If the user device 16 is not activated, the installer or client 54 may re-attempt to activate the user device 16.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of activating a user device comprising:
connecting the user device to a communication network;
communicating from the user device to a subscriber activation system through the communication network;
entering an ordering identifier into the user device;
communicating the ordering identifier to the subscriber activation system;
verifying the order identifier;
generating an activation signal from the order identifier; and
communicating the activation signal to the user device to activate the user device.

2. A method as recited in claim 1 wherein connecting the user device comprises connecting a satellite set to box and communicating through a satellite to the satellite set top box.

3. A method as recited in claim 1 further comprising communicating a subscriber activation client application to the user device and storing the subscriber activation client application within the user service.

4. A method as recited in claim 3 wherein communicating a subscriber activation client comprises communicating the subscriber activation client to the user device through a satellite.

5. A method as recited in claim 1 wherein prior to connecting a user device comprises storing a subscriber activation client application within the user device.

6. A method as recited in claim 1 wherein entering an order identifier comprises entering an order identification number.

7. A method as recited in claim 1 wherein entering an order identifier comprises entering an account identifier.

8. A method as recited in claim 1 wherein entering an order identifier comprises entering and order identification number and an account identifier.

9. A method as recited in claim 1 further comprising communicating a receiver identifier to the authentication module.

10. A method as recited in claim 1 further comprising activating a billing account in response to verifying.

11. A method as recited in claim 1 further comprising communicating a sent signal to a billing module in response to the activation signal.

12. A method as recited in claim 11 further comprising, in response to the sent signal, activating an account at the billing module.

13. A method as recited in claim 1 wherein communicating the ordering identifier to the subscriber activation system comprises communicating the ordering identifier to the subscriber activation system through a phone line.

14. A method as recited in claim 1 wherein communicating the ordering identifier to the subscriber activation system comprises communicating the ordering identifier to the subscriber activation system through a broadband connection.

15. A method as recited in claim 1 wherein communicating the ordering identifier to the subscriber activation system comprises communicating the ordering identifier to the subscriber activation system using a hypertext transfer protocol post and response.

16. A method as recited in claim 1 wherein generating an activation signal from the order identifier comprises generating a conditional access packet from the order identifier.

17. A method as recited in claim 1 further comprising communicating the subscriber activation client application to the user device from a subscriber activation client download.

18. A method as recited in claim 1 wherein communicating from the user device comprises communicating from a mobile user device.

19. A system comprising:
a user device having a subscriber activation client application stored therein, said user device prompting entry of an ordering identifier and receiving the ordering identifier through a user interface; and
a subscriber activation system in communication with the user device through a secure network, said subscriber activation system receiving the ordering identifier from the user device, said subscriber activation system verifying the ordering information and generating an activation signal from the order identifier and communicating the activation signal to the user device to activate the user device.

20. A system as recited in claim 19 wherein the secure network comprises a telephone network.

21. A system as recited in claim 19 wherein the secure network comprises a broadband network.

22. A system as recited in claim 19 further comprising a satellite, said subscriber activation system communicating the activation signal to the user device through the satellite.

23. A system as recited in claim 19 wherein the user device comprises a satellite television set top box.

24. A system as recited in claim 19 wherein the user device comprises a mobile user device.

25. A method of activating a satellite television set top box comprising:
connecting the satellite television set top box to a subscriber activation system through a communication network;
storing subscriber activation client application on the satellite television set top box;
activating the subscriber activation client application by accessing a channel in the satellite television set top box;
entering an ordering identifier into the satellite television set top box in response to prompts from the subscriber activation client;
communicating the ordering identifier to the subscriber activation system through the communication network;
verifying the order identifier;
generating an activation signal from the order identifier; and
communicating the activation signal to the satellite television set top box through the satellite to activate the user device.
